(19) United States
(12) Patent Application Publication
(10) Pub. No.: US 2024/0390718 A1
(43) Pub. Date: Nov. 28, 2024

(54) DEVICES, SYSTEMS, AND METHODS FOR APPLICATION OF FIRE RETARDANT

(71) Applicant: Nicholai Ryan ALLEN, Las Vegas, NV (US)

(72) Inventor: Nicholai Ryan ALLEN, Las Vegas, NV (US)

(21) Appl. No.: 18/696,231

(22) PCT Filed: Sep. 27, 2022
(86) PCT No.: PCT/US2022/044925

§ 371 Date: Mar. 27, 2024

Related U.S. Application Data
(60) Provisional application No. 63/249,475, filed on Sep. 28, 2021.
(60) Provisional application No. 63/395,690, filed on Aug. 5, 2022.

(51) Int. Cl. A62C 31/02; A62C 27/00

(52) U.S. Cl. CPC A62C 31/02; A62C 27/00

(57) ABSTRACT

A system for applying a fire retardant with a hose includes a nozzle, a straw coupled to the nozzle, and a container coupled to the nozzle with fire retardant liquid in the container. The nozzle is connected to a hose, such as a garden hose, and mixes the fire retardant liquid with water to create a fire retardant mixture. The nozzle discharges the fire retardant mixture onto a structure or another selected location to reduce the risk of damage due to fire. The system may also be adapted for use with a vehicle for mixing and applying the fire retardant mixture onsite in commercial applications.

### BACKGROUND

### Technical Field

The present disclosure is directed to devices, systems, and methods for mixing and applying a fire retardant, and is particularly but not exclusively, directed to a nozzle for mixing and applying a fire retardant with a garden hose and a vehicle for onsite mixing and application of fire retardant.

### Description of the Related Art

Wildfires and forest fires are an increasing threat to the safety of property and human lives because of climate change and other factors. In the current market, there are limited options for protecting property from the damage and destruction of a fire. Some options, some as private firefighters, are prohibitively expensive for many users and difficult to acquire given competition for limited resources. In response, certain solutions utilizing fire retardants for individual and commercial use have been proposed.

One example fire retardant is a type of gel that can be applied to a structure or a perimeter of a property to slow an advancing fire and potentially reduce damage to the structure or property from a fire. However, such fire retardant gels have a number of disadvantages. For example, they are mixed with a special applicator, such as a pressurized mix can or an aerosol mix apparatus that most users would not have on hand in the event of an emergency evacuation order due to the threat of an advancing fire. Even if a user does have the mixing apparatus, the specialized nature of the apparatus makes the applicators difficult to use effectively. Further, the fire retardant gel needs to be repeatedly wet down with water to remain effective. As an example, the gel needs to be wet down with water every day or two to remain effective at preventing the spread of fire. Naturally, this is an ineffective solution for users that must evacuate due to the threat of an advancing fire because they are not able to apply water to the gel. Further, the gel can leave stains if applied to a structure and requires expensive clean up, such as power washing, for effective removal after the risk of fire has reduced.

Another example type of fire retardant is the fire retardant powder that is commonly dropped by helicopters or planes on an advancing fire in an effort to slow the progress of the fire or to protect structures and properties. These types of fire retardant have similar disadvantages to the above, namely, they can stain structures and are difficult to clean after a threat of fire has passed. In addition, these powders can cause a health concern upon a return to a property and are not well suited for application in remote areas because the helicopter or plane can only carry a certain amount of fire retardant powder and thus must make multiple trips to load and drop more powder. The additional trips significantly increase operational costs and reduce efficiency because it takes more time for the helicopter or plane to apply fire retardant to a given area. It would therefore be desirable to have a fire retardant system that overcomes the shortcomings of conventional fire retardant devices.

### BRIEF SUMMARY

The present disclosure is generally directed to fire retardants for preventing the spread of fire that can be rapidly applied in the event of an emergency or impending fire. In some examples, a nozzle is connected to a container with fire retardant liquid in the container. The nozzle is coupled to a common garden hose and the nozzle mixes the liquid with water to form a fire retardant mixture that is discharged from the nozzle under pressure from the water in the garden hose. The fire retardant mixture can then be applied to structures and property to slow the spread of fire or prevent fire from spreading to the property. The fire retardant mixture washes off with water after the fire threat has passed. Further, the fire retardant mixture puts out the fire by a chemical reaction that does not require re-application of water to remain effective.

In a further example, a vehicle is provided that can create the fire retardant liquid onsite at a location from chemical reagents stored on the vehicle. The reagents are mixed with heated water to create the fire retardant liquid. Then, the liquid may be applied directly or mixed with additional water and applied to a structure or property. The use of a vehicle to mix and apply fire retardant onsite at a location allows for efficient application of fire retardant in a large area with significantly reduced costs and is particularly well suited for remote areas. The fire retardant mixture described herein may also be used for agricultural purposes to protect crops from fire, such as at a winery in one non-limiting example. The fire retardant mixture is non-toxic and odor free and does not stain or soil food. Rather, the mixture dries after application and rinses off with water, without having to use any special process or pressure washing tools. Thus, the fire retardant mixture may also be particularly well suited to protecting crops and other vegetation.

The present disclosure also includes example methods of mixing and applying fire retardant that will be described in more detail below.

In one or more embodiments, a system for applying a fire retardant with a hose may be summarized as including: a nozzle including a first fluid inlet, a second fluid inlet in fluid communication with the first fluid inlet, the second fluid inlet being coupleable to the hose, and a fluid outlet in fluid communication with the first fluid inlet and the second fluid inlet to define a fluid path through the nozzle; a straw coupled to the first fluid inlet of the nozzle; a container removably coupled to the first fluid inlet of the nozzle with the straw received in the container; and a fire retardant liquid in the container, the nozzle structured to receive water from the hose via the second fluid inlet of the nozzle and mix the water with the fire retardant liquid in the container via the straw and the first fluid inlet to create a fire retardant mixture and discharge the fire retardant mixture through the fluid outlet of the nozzle under pressure from water in the hose.

The system may further include an air hole in the nozzle or container, or both, to allow air to enter the container and replace the fire retardant liquid that is leaving the container through the straw. The air hole allows the fluid to exit without creating a vacuum in the container and thus minimizes the potential that suction will be blocked and the fire retardant liquid will not be mixed with water.

The system may further include: the nozzle further including a first valve in fluid communication with the fluid path between the first fluid inlet and the fluid outlet, the first valve being manipulatable between a closed position and an open position; the nozzle further including a second valve in fluid communication with the fluid path between the second fluid inlet and the fluid outlet, the second valve being manipulatable between a closed position and an open position; the first valve controlling only introduction of the fire retardant chemical to the fluid path and the second valve controls only introduction of water into the fluid path; and the nozzle including a first collar corresponding to the first fluid inlet and having a first diameter and a second collar corresponding to the second fluid inlet and having a second diameter less than the first diameter.

The system may further include: the container having a neck with a plurality of threads structured to engage the first collar; the straw having a length from a first end to a second end opposite to the first end, the straw including a longitudinal axial bore through the straw from the first end to the second end, the longitudinal axial bore defined by an inner surface of the straw including a plurality of lands and grooves in a spiral configuration to increase velocity of the fire retardant liquid through the straw; the nozzle being structured to discharge the fire retardant mixture at least 15 feet from the nozzle; the container having a volume between 8 fluid ounces and 192 fluid ounces; and the fire retardant mixture having a ratio of water to fire retardant liquid between 1:5 and 1:15.

The system may further include: the container having a handle; the container being a first container with a first thread ratio being coupleable with the first fluid inlet of the nozzle, the system further comprising a second container with a second thread ratio different than the first thread ratio; and an adapter including a first connector with the first thread ratio and a second connector with the second thread ratio, the adapter being coupleable to the first fluid inlet of the nozzle and the second container.

In one or more embodiments, a vehicle for mixing and applying a fire retardant may be summarized as including: at least one chemical storage tank coupled to the vehicle or towed by the vehicle or associated with a second vehicle; at least one reagent in the at least one chemical storage tank; a heating element coupled to the vehicle or as an annex towed by the vehicle or associated with the second vehicle; a water softener; a water inlet in fluid communication with the heating element, and the water softener, the water inlet being coupleable to a water source; a mixing tank; and a fluid outlet in fluid communication with the mixing tank, the mixing tank structured to receive heated water from the heating element and the at least one chemical reagent from the at least one chemical storage tank to create a fire retardant mixture in the mixing tank, the fluid outlet structured to discharge the fire retardant mixture from the mixing tank.

The vehicle may further include: the at least one reagent being one or more of sodium chloride, ammonium dihydrogenphosphate, and ammonium hydrogen carbonate; the heated water having a temperature ranging from 30 degrees Celsius to 70 degrees Celsius; and the fire retardant mixture including a surfactant.

### BRIEF DESCRIPTION OF THE SEVERAL VIEWS OF THE DRAWINGS

The present disclosure will be more fully understood by reference to the following figures, which are for illustrative purposes only. These non-limiting and non-exhaustive embodiments are described with reference to the following drawings, wherein like labels refer to like parts throughout the various views unless otherwise specified. The sizes and relative positions of elements in the drawings are not necessarily drawn to scale in some figures. For example, the shapes of various elements are selected, enlarged, and positioned to improve drawing legibility. In other figures, the sizes and relative positions of elements in the drawings are exactly to scale. The particular shapes of the elements as drawn may have been selected for ease of recognition in the drawings. The figures do not describe every aspect of the teachings disclosed herein and do not limit the scope of the claims.

FIG. 1 is an isometric view of an embodiment of a nozzle for mixing and applying a fire retardant mixture according to the present disclosure.

FIG. 2 is a right side elevational view of the nozzle of FIG. 1.

FIG. 3 is a detail view of area A in FIG. 2.

FIG. 4 is a rear elevational view of the nozzle of FIG. 1.

FIG. 5 is a front elevational view of the nozzle of FIG. 1.

FIG. 6 is a top plan view of the nozzle of FIG. 1.

FIG. 7 is a bottom plan view of the nozzle of FIG. 1.

FIG. 8 is a front elevational view of the nozzle of FIG. 1 coupled to a container containing retardant liquid.

FIG. 9 is a right side elevational view of the nozzle and container of FIG. 8.

FIG. 10 is a plan view and a cross-sectional view of a straw of the nozzle and container of FIG. 9.

FIG. 11 is a schematic illustration of an embodiment of a vehicle for mixing and applying a fire retardant mixture according to the present disclosure.

FIG. 12 is an isometric view of an embodiment of a nozzle according to the present disclosure.

FIG. 13 is a top plan view of a flow control device of the nozzle of FIG. 12.

FIG. 14 is an isometric view of the flow control device of FIG. 13.

FIG. 15 is a right side elevational view of the flow control device of FIG. 13.

### DETAILED DESCRIPTION

Persons of ordinary skill in the art will understand that the present disclosure is illustrative only and not in any way limiting. Other embodiments of the presently disclosed technology readily suggest themselves to such skilled persons having the assistance of this disclosure.

Each of the features and teachings disclosed herein can be utilized separately or in conjunction with other features and teachings to provide fire retardant devices, systems, and methods. Representative examples utilizing many of these additional features and teachings, both separately and in combination, are described in further detail with reference to the attached Figures. This detailed description is merely intended to teach a person of skill in the art further details for practicing aspects of the technology and is not intended to limit the scope of the claims. Therefore, combinations of features disclosed in the detailed description may not be necessary to practice the teachings in the broadest sense, and are instead taught merely to describe particularly representative examples of the present teachings.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity, as well as limit values, for the purpose of original disclosure, as well as for the purpose of restricting the claimed subject matter. It is also expressly noted that the dimensions and the shapes of the components shown in the figures are designed to help understand how the present teachings are practiced, but are not intended to limit the dimensions and the shapes shown in the examples in some embodiments. In some embodiments, the dimensions and the shapes of the components shown in the figures are intended to limit the dimensions and the shapes of the components.

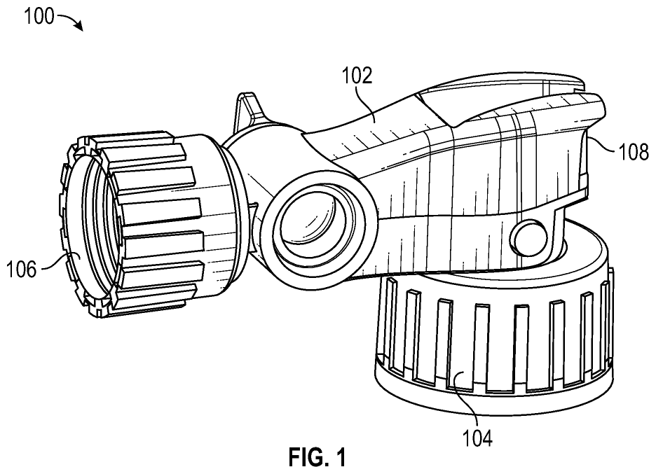

FIGS. 1-7 are various views of an embodiment of a nozzle 100 for mixing and applying a fire retardant mixture. As will be explained in greater detail below, the nozzle 100 is structured to receive water from a garden hose and mix the water with a fire retardant liquid to create a fire retardant mixture. The nozzle 100 is further structured to discharge the fire retardant mixture under pressure from water in the hose such that a user can apply a fire retardant mixture with the nozzle 100.

Beginning with FIG. 1, illustrated therein is an isometric view of the nozzle 100. The nozzle 100 includes a body 102 with a fluid path through the body 102 for mixing and discharging a fire retardant mixture of the type described herein. Specifically, the nozzle 100 includes a first fluid inlet 104, a second fluid inlet 106, and a fluid outlet 108 in fluid communication with each other to define the fluid path through the nozzle 100 from the inlets 104, 106 to the outlet 108. As shown in FIG. 1, the fluid path is not a straight line through the nozzle 100, but rather, includes a first line from the first inlet 104 to the outlet 108 and a second line from the second inlet 106 to the outlet 108 which may be substantially perpendicular to each other (i.e., within 5 degrees of perpendicular). In some embodiments, the lines meet at a selected location upstream of the outlet 108 (i.e., the intersection of lines through the first and second inlets 104, 106, which is spaced from the outlet 108) to allow for a brief mixing period of fluids in the lines before the mixture is discharged at the outlet 108. Alternatively, the lines may meet at the outlet 108 in one or more embodiments with the fluids mixing in the discharge stream from the outlet 108. In an embodiment, the first inlet 104 is larger in diameter or size than the second inlet 106 so that the first inlet 104 can be secured to a container of the type described herein, while the second inlet 106 can be secured to a garden hose or other water source. The opposite arrangement is also contemplated herein, namely the first inlet 104 being smaller for attachment to a hose, and the second inlet 106 being larger for attachment to a container. The inlets 104, 106 may also have the same size and shape with adapters for connections of different sizes to various external structures.

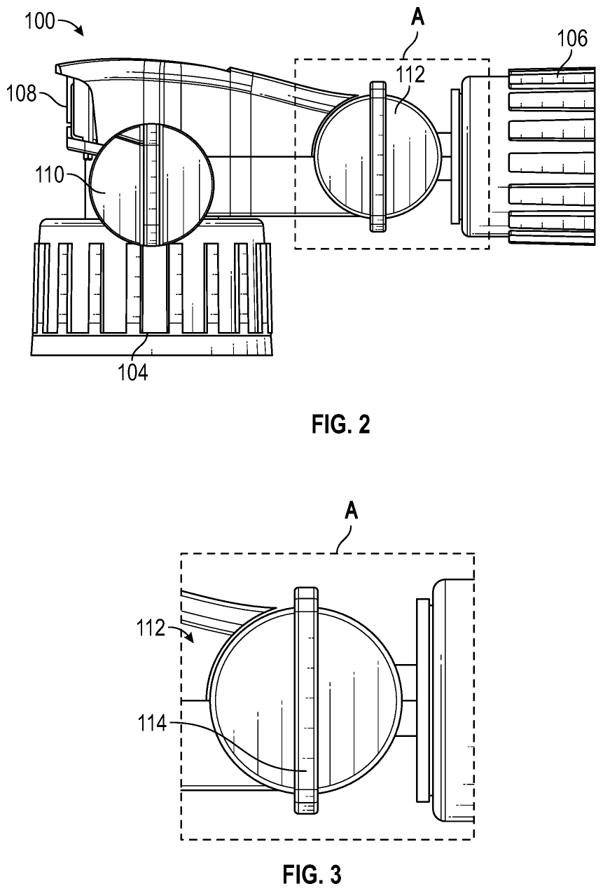

FIG. 2 is a right side elevational view of the nozzle 100 providing additional detail of the nozzle 100. The nozzle 100 includes a first valve 110 in fluid communication with the fluid path through the nozzle 100 that is positioned between the first fluid inlet 104 and the fluid outlet 108. In some embodiments, the first valve 110 controls introduction of only fluid (i.e., fire retardant liquid) through the first inlet 104 into the fluid path. The nozzle 100 also includes a second valve 112 in fluid communication with the fluid path and positioned between the second fluid inlet 106 and the fluid outlet 108. Similar to the first valve 110, the second valve 112 controls only the introduction of fluid from the second fluid inlet 106 into the fluid path in some embodiments. In other words, where the inlets 104, 106 are associated with respective fluid lines that are combined at, or upstream of, the fluid outlet 108, the first valve 110 may be operable to control fluid flow in the first fluid line associated with the first inlet 104 and the second valve 112 may be operable to control fluid flow in the second fluid line associated with the second inlet 106.

In FIG. 2, both of the valves 110, 112 are quarter turn rotary valves that are manipulatable between an open or “ON” position and a closed or “OFF” position by a 90-degree turn of the respective valve 110, 112. However, the present disclosure contemplates the use of any type of valve now known or developed in the future for the valves 110, 112, including but not limited to ball valves, butterfly valves, gate valves, knife gate valves, glove valves, needle valves, pinch valves, multi-turn valves, and plug valves in some non-limiting examples. Further, the present disclosure contemplates the use of a single valve in place of valves 110, 112 that allows for application of water in a first position of the valve or application of water mixed with the fire retardant liquid in a second position of the valve. The use of two valves 110, 112 enables a user to selectively control introduction of fire retardant liquid through first valve 110 while also selectively controlling water flow via valve 112, such that water only, or a combination of water and fire retardant liquid, can be output via fluid outlet 108 based on the selections of the user. Such an arrangement may also be possible with a single valve, as above. In addition, the first valve 110 may instead control introduction of water and the second valve 112 may instead control introduction of fire retardant liquid in some embodiments. The second valve 112 may be aligned with the first valve 110, meaning the valves 110, 112 have the same vertical height relative to the first inlet 104, or the valves 110, 112 may be offset from each other relative to the first inlet 104, meaning one valve 110, 112 has a greater or less vertical height relative to the first inlet 104 relative to the other valve 110, 112. Except as otherwise provided herein, “upstream” and “downstream” refer to a location of a component relative to the direction of fluid flow into and through the nozzle 100 toward the fluid outlet 108. Thus, the second valve 112 may be upstream of the first valve 110 relative to fluid outlet 108, meaning that the second valve 112 is further from the fluid outlet 108 than the first valve 110. The second inlet 106 may be upstream of the first inlet 104 in a similar manner.

FIG. 3 is a detail view of the second valve 112 showing that the valve 112 may include a ridge or protrusion 114 extending from an external face of the valve 112 to enable the user to more easily manipulate the valve 112. The orientation of the ridge or protrusion 114 may also indicate whether the valve 112 is in the open or closed position in some embodiments. For example, in FIG. 3, the ridge 114 is positioned vertically when the valve 112 is in the open or “ON” position. Similarly, the ridge 114 may be positioned horizontally when the valve 112 is in the closed or “OFF” position. In some embodiments, the valve 112 has an opposite configuration where the ridge 114 is aligned horizontally in the open configuration and vertical in the closed configuration. Further, the ridge 114 may extend across the entire face of the valve 112 or may extend only a selected distance across the face of the valve 112. Still further, the ridge 112 may include two or more separate component pieces, such as two ridges spaced from each other across the face of the valve in some embodiments, among many other configurations, such as multiple ridges, bumps, or protrusions arranged in a selected pattern and with selected spacing.

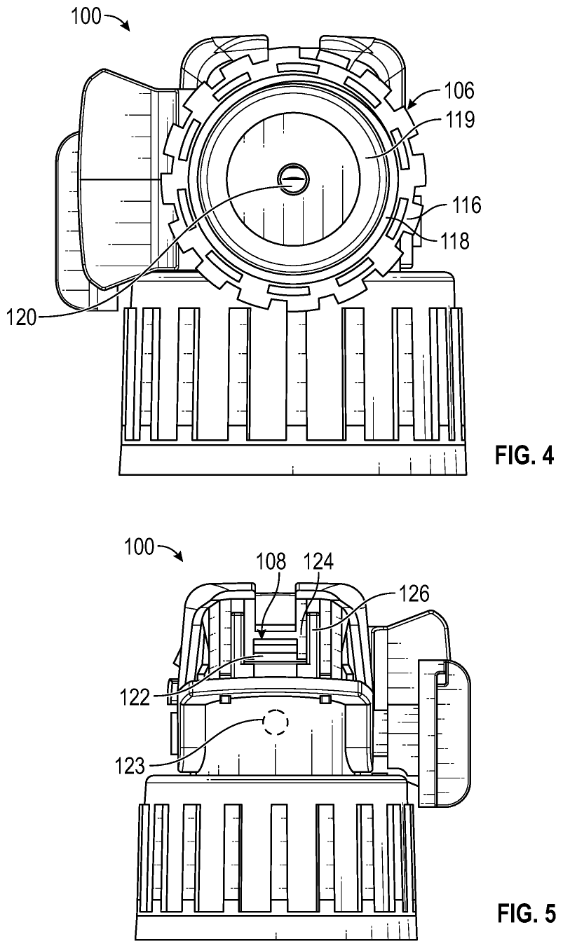

FIG. 4 is a rear elevational view of the nozzle 100 illustrating the second fluid inlet 106 in more detail. The nozzle 100 includes a collar 116 associated with the second inlet 106 that includes threads 118 structured to receive and engage threads on a garden hose. Thus, in some embodiments, the threads 118 are ¾ inch threads with 11.5NH thread pitch for engaging a standard ¾ inch male garden hose connector. However, the collar 116 and threads 118 may be any selected size and with any selected thread pitch for different applications, such as ⅝ inch threads for connecting to smaller hoses in one non-limiting example. In some embodiments, the nozzle 100 may be sold with a step-up or step-down adapter for connecting the ¾ inch threads of the second inlet 106 with a hose connector with a different size, such as a ¾ inch to ⅝ inch adapter. The second fluid inlet 106 also includes an inlet hole 120 in fluid communication with the fluid path for providing water from the second inlet 106 through the hole 120 and into the fluid path of the nozzle 100. The second fluid inlet 106 also includes a washer or gasket 119 internal to the collar 116 for providing a seal between the hose and the second fluid inlet 106, and for directing water through and into the hole 120, in one or more embodiments. The nozzle 100 may also include a backflow prevention valve or device associated with the inlet hole 120 to prevent backflow of the fluid in the fluid path into the water supply via the garden hose under negative pressure, such as when the garden hose is turned off.

FIG. 5 is a front elevational view of the nozzle 100 providing additional detail regarding the fluid outlet 108. The fluid outlet 108 includes a discharge hole 122 in fluid communication with the fluid path of the nozzle 100 for discharging fluid under pressure from the garden hose connected to the second fluid inlet 106. In some embodiments, the discharge hole 122 may have a square or rectangular shape defined by interlocking protrusions such as first and second protrusions 124, 126. The top and sides of the discharge hole 122 are defined by the first protrusion 124 which extends downward from a top of the nozzle 100 and has an H shape that opens into the discharge hole 122. The second protrusion 126 has an upwardly facing U shape that defines the bottom of the discharge hole 122 and extends around, and interlocks with the H shape of the first protrusion 124.

In some embodiments, the discharge hole 122 has a size and a shape that is adapted to discharge fluid in a selected pattern (such as a stream or a fan pattern) and over a selected distance based on the standard water pressure from a garden hose (i.e., between 40 to 60 pounds per square inch or “psi”) in an example. In some non-limiting examples, the rectangular shape of the discharge hole 122 may discharge fluid in a thick fan or trapezoidal shape that throws the liquid from the nozzle 100 at least 10 feet, at least 15 feet, at least 20 feet, at least 25 feet, or at least 30 feet or more or less.

However, the size and shape of the hole 122 may be selected to vary the output characteristics of the nozzle 100. For example, the discharge hole 122 may be selected to have a smaller size or diameter to increase the pressure at the discharge hole 122 and reduce the output volume in order to increase the pressure and discharge the fluid further. Alternatively, the discharge hole 122 may have a larger size to increase the output volume at reduced pressure. Still further, the size of the outlet hole 122 may be adjustable in some embodiments by a rotary valve or a manipulatable switch or toggle to allow the user to change the configuration of the outlet hole 122 to suit the situation.

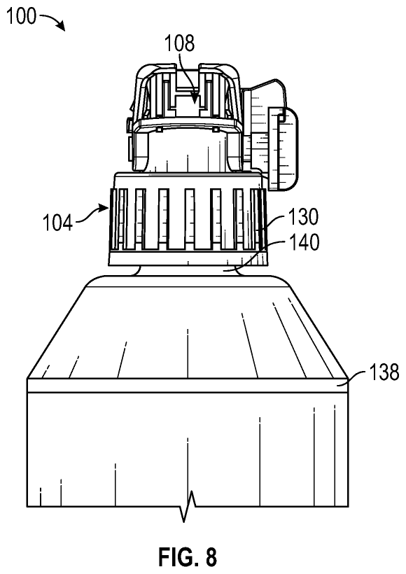

In some embodiments, the nozzle 100 further includes an air hole or air intake 123 in the nozzle 100. The air hole 123 is in fluid communication with a container coupled to the nozzle 100 (such as container 138 in FIG. 8) and allows air to enter the container to replace the fire retardant liquid that leaves the container during operation of the nozzle 100. The air hole 123 prevents the formation of a vacuum in the container and thus minimizes the likelihood that the fire retardant liquid will be blocked or prevented from leaving the container to be mixed with water, as described herein. The air hole 123 may be associated with the fluid outlet 108, or may be at another selected location on the nozzle 100. Thus, the air hole 123 is illustrated schematically with dashed lines in FIG. 5 to indicate that the location and size of the air hole 123 can be selected. Still further, the air hole 123 may be associated with a flow path into the nozzle 100 and container that is separate and distinct from the fluid flow paths described elsewhere herein, such that fluids will not exit the nozzle through the air hole 123, and air is not introduced into the fluid flow paths. In some embodiments, the container includes the air hole 123 or a vent for providing air into the container instead of the air hole 123 in the nozzle or in yet further embodiments, both the nozzle and the container include an air hole or vent 123.

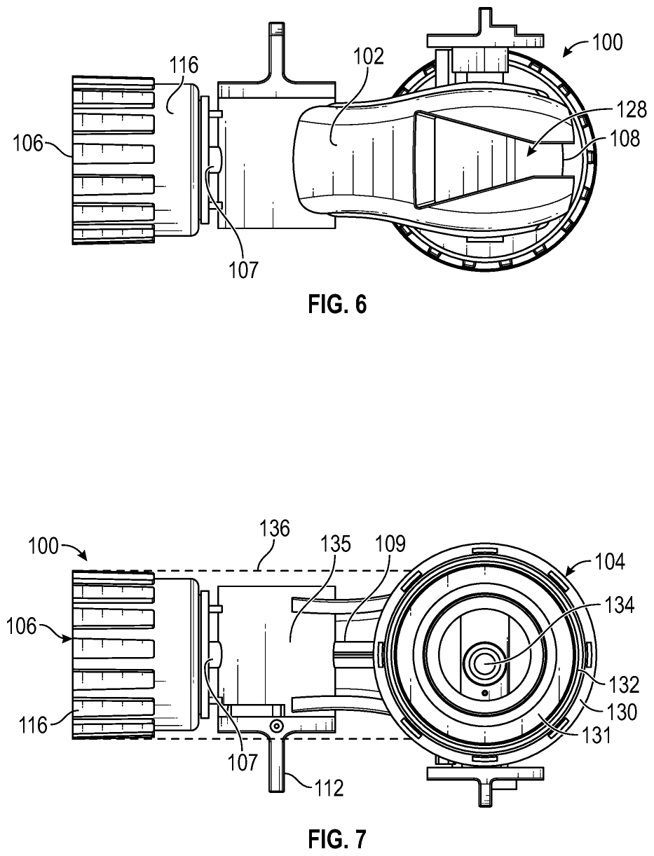

FIG. 6 is a top plan view of the nozzle 100. The nozzle 100 includes a channel 128 in a top surface of the nozzle 100 that may indicate a direction of the output spray from the nozzle 100. In some embodiments, the channel 128 has a triangular base with a continuously tapering and narrowing width to an extension at the vertex of the triangular base with the extension having a constant width. Thus, the channel 128 may have a base with a width greater than a width of the extension at the outlet 108 in order to form a shape related to an arrow indicating the direction of the outlet spray. The channel 128 may also be provided for the structural integrity of the nozzle 100, or to reduce the amount of materials used in forming the nozzle 100, or to adapt the structure of the nozzle 100 to different methods of forming or molding the nozzle 100. FIG. 6 also demonstrates that the second inlet 106 and the collar 116 are a separate and distinct component from the body 102 of the nozzle with the second inlet 106 and the collar 116 coupled to the body 102 of the nozzle 100. In one or more embodiments, the second inlet 106 and the collar 116 are a single, integral, unitary structure with the body 102 of the nozzle 100. Fluid flow through the second inlet 106 is provided to flow line 107 in fluid communication with the second inlet 106 and the fluid outlet 108 through the body 102 of the nozzle 100.

FIG. 7 is a bottom plan view of the nozzle 100 providing additional detail of the first fluid inlet 104. The nozzle 100 includes a collar 130 corresponding to the first fluid inlet 104 that similarly includes threads 132. The first fluid inlet 104 further includes an inlet hole 134 in fluid communication with the fluid path. The inlet hole 134 is structured to receive a straw that is inserted into a container holding fire retardant liquid, as explained in further detail below with reference to FIGS. 8-10. Further, the collar 130 and the threads 132 are structured to receive and engage corresponding threads on the container. Similar to the second fluid inlet 106, the first inlet 104 may further include washers or gaskets 131 received in the collar 130 proximate the interface with the inlet hole 134 to provide a watertight seal between the first fluid inlet 104 and the container. The first fluid inlet 104 may also include a backflow device, similar to the second fluid inlet 106 in one or more embodiments.

The collar 116 of the second fluid inlet 106 has a diameter that is less than a diameter of the collar 130 of the first fluid inlet 104 in a preferred embodiment, as indicated by dashed lines 136 in FIG. 7. The larger size of the collar 130 of the first fluid inlet 104 allows for connection of the collar 130 to a larger container for supplying a larger volume of fire retardant liquid to the nozzle 100 before replacing the container. Further, the inlet hole 134 of the first inlet 104 is larger in size than the inlet hole 120 in the second inlet 106 (FIG. 4) not only to receive the straw but also to increase the volume of fire retardant liquid pulled into the fluid path of the nozzle 100 from the container to increase the concentration of the fire retardant liquid relative to water in the mixture that is discharged from the nozzle 100. In an embodiment, fluid from the container that travels through inlet hole 134 is provided to flow line 109 that is in communication with flow line 107 via a barrel 135 of the nozzle 100. The barrel 135 may receive the second valve 112 with mixing of the water and fire retardant liquid occurring in the barrel 135 in some non-limiting examples.

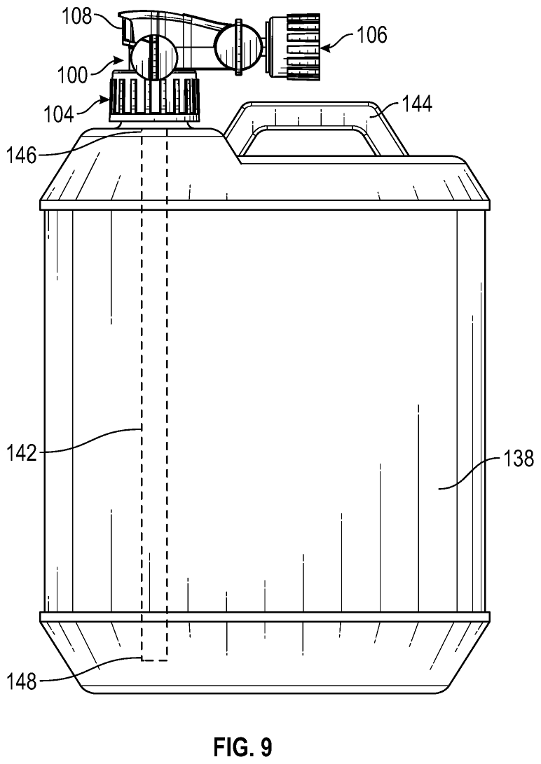

FIG. 8 and FIG. 9 illustrate the nozzle 100 coupled to a container 138 for storing and supplying fire retardant liquid to the nozzle 100. Beginning with FIG. 8, the collar 130 of the first fluid inlet 104 of the nozzle 100 is coupled to a corresponding neck 140 of the container 138. Although not specifically shown in FIG. 8, it is to be appreciated that the neck 140 of the container 138 similarly includes a plurality of threads structured to engage the threads 132 (FIG. 7) of the collar 130 of the first fluid inlet 104. The user therefore rotates the collar 130 to secure the collar 130 and the nozzle 100 to the neck 140 of the container 138. FIG. 8 also provides further detail of the outlet 108 of the nozzle 100 and in particular, illustrates the square shape of the outlet 108 and small spaces on either side of the outlet 108 for widening the fluid discharge in some embodiments.

In an embodiment, the threads of the container 138 may have a first thread ratio that corresponds to a thread ratio of the collar 130 of the first fluid inlet 104 of the nozzle 100. In some embodiments, the container 138 may have a different thread ratio than the collar 130, such as a container 138 with a different volume in one non-limiting example (i.e., a container 138 with a smaller volume may have a smaller thread ratio). In such an embodiment, the nozzle 100 may include an adapter with a first connector with a thread ratio corresponding to the collar 130 of the nozzle 100 and a second connector with a thread ratio corresponding to the container 138. The adapter is coupled between the nozzle 100 and the container 138 to allow containers 138 with different thread ratios to be used with the nozzle 100.

Turning to FIG. 9, the container 138 is shown in more detail. As described above, the nozzle 100 is coupled to a straw 142 illustrated in FIG. 9 in dashed lines. The straw 142 connects to the inlet hole 134 of the first fluid inlet 104 (FIG. 7) and extends to be received internally in the container 138. Further, FIG. 9 illustrates that the container 138 includes a handle 144 to assist the user with holding the container 138 during application of fire retardant, although the same is not necessarily required and the container 138 may not include the handle 144 in some embodiments. Instead, the nozzle 100 may contain a handle at a selected location on the nozzle 100, or the system may not include any handles and the user grasps the nozzle 100 for applying the mixture. Further, the container 138 and the nozzle 100 may be formed of any plastic in a preferred embodiment by any method now known or developed in the future, including but not limited to casting, injection molding, blow molding, compression molding, rotational molding, and other like processes. The container 138 and the nozzle 100 may also be formed of any other material in some embodiments, such as metal, glass, and the like. In some embodiments, the container has a capacity of at least one gallon in order to allow the user to apply more fire retardant before switching containers, although containers of any size and shape are contemplated herein. In one non-limiting example, the container 138 has a volume between 8 fluid ounces and 192 fluid ounces or more.

The container 138 is structured to receive and store a fire retardant liquid that is introduced to the fluid path in the nozzle 100 via the straw 142 and the first fluid inlet 104. At the nozzle 100, the fire retardant liquid is mixed with water from the second fluid inlet 106 and the garden hose to create a fire retardant mixture that is discharged at the fluid outlet 108 of the nozzle 100. The passage of water through the nozzle 100 from the second inlet 108 creates negative pressure in the straw 142 that draws fire retardant liquid from the container 138 into the fluid path in the nozzle 100 through the straw 142 and the first inlet 104 when both valves 110, 112 are in the open or “ON” position. As described above, the nozzle 100 is structured to spray the fire retardant mixture at least 15 feet in some embodiments in order to allow a user to apply the mixture to multiple stories of a structure as well as the eaves, roof, and other elevated aspects of a structure. Moreover, the size of the straw 142 and the configuration of the straw 142 and the first inlet 104 can be selected to provide a concentration of fire retardant mixture to water between 1:1 and 1:20 in some embodiments, or more preferably between 1:5 and 1:15, and even more preferably between 1:6 and 1:20, and most preferably approximately 3:20 or 15% of fire retardant liquid to water.

The concentration of the fire retardant mixture to water using the nozzle 100 and other concepts of the disclosure are improvements over known nozzles because the fire retardant liquid in the container 138 is more effective at higher concentrations that are not achievable with known nozzles. For example, the typical concentration of the fire retardant mixture to water using a known nozzle may be 1:25 and typically not higher than 1:15. At these lower concentrations using a typical nozzle, the fire retardant liquid may not be present in a high enough concentration to effectively prevent or slow an advancing fire. Thus, the size of the various aspects of the nozzle 100 as well as the features of the nozzle 100 generally, are selected to provide for higher concentrations of fire retardant liquid to water to improve the effectiveness of the fire retardant mixture discharged from the nozzle 100.

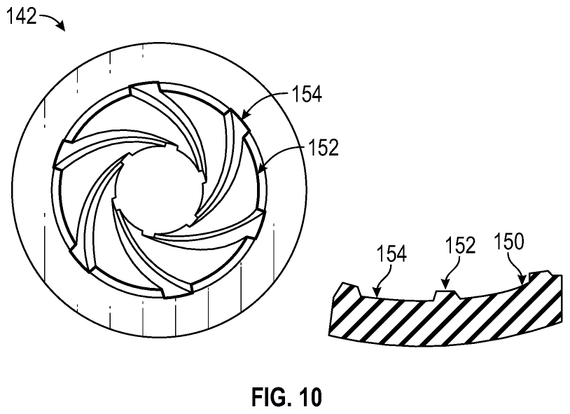

One feature that assists with drawing additional fire retardant liquid from the container 138, among others described herein, is the design of the straw 142 illustrated in FIG. 10. With reference to FIG. 9 and FIG. 10, the straw 142 may have a length from a first end 146 to a second end 148 opposite the first end 146 with a longitudinal axial bore through the straw 142 from the first end 146 to the second end 148. The bore is defined by an inner surface 150 of the straw 142 illustrated in FIG. 10. In some embodiments, the straw 142 includes a plurality of lands 152 and a plurality of grooves 154 between the lands 152 on the inner surface 150 of the straw 142 that are arranged in a helical or other selected pattern along the length of the straw 142 to increase the velocity of the fire retardant liquid through the straw 142. In other words, the lands 152 and grooves 154 assist with creating a vortex in the straw 142 that increases fluid velocity through the straw 142 and creates additional negative pressure toward the remaining liquid in the container 138 to assist with drawing larger volumes of liquid from the container 138. The increased velocity from the design of the straw 142 results in a larger volume of fire retardant liquid being drawn from the container 138 at the same pressure relative to a straw without the lands and grooves 152, 154. The lands 152 and grooves 154 may be present in a continuous or constant alternating helical pattern over an entire length of the straw 142, or may be present along only selected portions of the straw 142 in some embodiments. Thus, the design of the straw 142 assists, at least in part, in providing a larger volume of fire retardant liquid and creates a higher concentration of fire retardant liquid to water at the nozzle 100 than is achievable with conventional nozzles and straws.

The fire retardant liquid is stored in the container 138 and a user may keep one or more containers in their house for rapid application of the fire retardant mixture in the event of an emergency. Moreover, because the nozzle 100 is attachable to a common garden hose and is easy to use (i.e., adjust the valves to “ON,” turn on the hose, and spray), the concepts of the disclosure are more widely applicable. Further, the user does not need to reapply water to the mixture after spraying because the mixture is not a gel or foam that must be wet to be effective. Rather, the fire retardant mixture extinguishes fire by a chemical reaction that is catalyzed by the heat from the fire, as described below. The fire retardant mixture may also be water soluble, clear, non-toxic and odor free such that it does not leave stains and is not difficult to clean up after the threat of fire has passed. In some embodiments, the fire retardant liquid is free of toxins and other chemicals or chemical byproducts that are a danger to human health and crops. In an embodiment, the fire retardant liquid is mixed with water to provide approximately 15% (i.e., between 12% and 18%) fire retardant liquid mixed into the water on dispersion from the nozzle 100. While 15% is effective and practical for slowing fire, in a preferred embodiment, the user applies the mixture to a selected area or structure twice to increase the amount of fire retardant liquid to 30%. The nozzle 100 and container 138 may also be adapted to provide a 30% or approximately 30% (i.e., between 27% and 33%) fire retardant liquid to water mixture for single pass applications.

The fire retardant liquid may be a combination of a number of different chemical agents formed according to certain processes. In one example, a process for producing the fire retardant liquid includes dissolving sodium chloride, ammonium dihydrogenphosphate and ammonium hydrogen carbonate in hot water at a temperature of 30 degrees to 40 degrees Celsius to form a solution. The sodium chloride may be present in a ratio of 5 grams (“g”) to 15 g per 500 milliliters (“ml”) of water, the ammonium dihydrogenphosphate may be present in a ratio of 50 g to 70 g per 500 ml of water, and the ammonium hydrogen carbonate may be present in a ratio of 50 g to 70 g per 500 ml of water. In some embodiments, the process further includes incorporating a surfactant into the fire retardant liquid.

In more detail, 5 g to 15 g of sodium chloride is incorporated in 300 ml of water at a temperature ranging from 30 to 40 degrees Celsius and the mixture is stirred to dissolve the sodium chloride into the water. The sodium chloride is utilized as a catalyst according to the further concepts below. Subsequently, 50 g to 70 g of ammonium dihydrogenphosphate and 50 g to 70 g of sodium hydrogen carbonate are incorporated into the sodium chloride and water solution. Then, 200 ml of boiling water is added to the solution to bring the total amount of liquid to 500 ml, and the temperature to about 60 degrees to 70 degrees Celsius. The solution is then allowed to cool to room temperature.

In some embodiments, a surfactant is added to the solution in a ratio of approximately 20 ml of surfactant to 500 ml of solution. The above ratios also apply to producing the fire retardant liquid for larger volumes of water.

Ammonium dihydrogenphosphate and ammonium hydrogen carbonate are thermally decomposed into carbon dioxide gas (CO₂) and ammonia gas (NH₃) by combustion when the solution encounters fire. In other words, the heat from the fire produces a chemical reaction that acts to suppress fire and prevent fire from spreading.

The carbon dioxide gas prevents the supply of oxygen to the fire and therefore neutralizes and suppresses oxidation of burning products. Ammonia gas also has a neutralization function and a cooling function and therefore prevents re-ignition of burning products to prevent fire from spreading to surroundings. The reactions brought about when the solution encounters fire or is catalyzed by heat from a fire are as follows:

(NH₄)₂HPO₃+NH₄HCO₃→PO₄+H₂O+4NH₃+CO₂

PO₄+H₂O+4NH₃+CO₂+CO(NH₂)₂→(2NH₃)₃PO₄+2CO₂+H₂

After the above processing steps, the fire retardant liquid is stored in the container 138 and ready for use. As described above, the container 138 may be any one of a number of different kinds of containers and preferably is a type of material, such as various plastics, that are inert and do not deteriorate the quality of the fire retardant liquid. In other words, the material for the container 138 is selected in some embodiments to be a material that allows for stable storage of the fire retardant liquid without reacting with the liquid.

In a second example, a process for producing the fire retardant liquid includes dissolving sodium chloride, ammonium dihydrogenphosphate, ammonium hydrogen carbonate, urea and ammonium sulfate in hot water at a temperature of 30 degrees to 40 degrees Celsius. The sodium chloride is present in the extinguishing agent in a ratio of 5 g to 15 g per 500 ml of water, the ammonium dihydrogenphosphate is present in the extinguishing agent in a ratio of 50 g to 70 g per 500 ml of water, the ammonium hydrogen carbonate is present in the extinguishing agent in a ratio of 50 g to 70 g per 500 ml of water, the urea is present in the extinguishing agent in a ratio of 20 g to 40 g per 500 ml of water, and the ammonium sulfate is present in the extinguishing agent in a ratio of 35 g to 55 g per 500 ml of water. In some embodiments, the process further includes incorporating a surfactant into the fire retardant liquid.

In more detail, the process beings with 5 g to 15 g of sodium chloride incorporated in 300 ml of water at 30 degrees Celsius. The mixture is stirred to dissolve the sodium chloride into the water with sodium chloride utilized as a catalyst. Then, 50 g to 70 g of ammonium dihydrogenphosphate is dissolved into the solution followed by 50 g to 70 g of ammonium hydrogen carbonate. Subsequently, 20 g to 40 g of urea is dissolved in the solution followed by 35 g to 55 g of ammonium sulfate. After the urea, 200 ml of boiling water is added to the solution to bring the total amount of liquid to 500 ml and to raise the temperature of the solution to about 60 to 70 degrees Celsius. The solution is then allowed to cool to room temperature. Finally, in some embodiments, 20 ml of surfactant such as alpha foam is added to the 500 ml of fire retardant liquid.

In some embodiments, the process may include, before the addition of water, passing the water from a water supply through a water softener to control the hardness and mineral content of the water in the water supply before mixing with the reagents. Controlling and adjusting the properties of the water supply prior to mixing with the water softener improves the chemical mix and surfactant bonding and reduces the likelihood of sedimentation or separation of the reagents from the mixture.

The addition of boiling water after the ammonium dihydrogenphosphate, ammonium hydrogen carbonate, urea, and ammonium sulfate raises the temperature of the solution and may generate relatively large amounts of ammonia and carbon dioxide before the container is closed off or before the liquid is loaded into container 138. The loss and resulting shortage of ammonium dihydrogenphosphate, ammonium hydrogen carbonate, and ammonium sulfate can adversely affect the fire extinguishing properties of the liquid in some embodiments but not to a degree that the liquid is ineffective. On the other hand, the addition of lukewarm or hot water (instead of boiling) causes relatively small amounts of ammonia and carbon dioxide to be produced before the container 138 is sealed. It has been found from certain experiments that despite the addition of boiling water and the subsequent loss of ammonium dihydrogenphosphate, ammonium hydrogen carbonate, and ammonium sulfate, the containers are less susceptible to crack when stored in warm temperatures when using boiling water because of the release of the gases that would otherwise increase pressure in the container at warmer storage temperatures (i.e., 30 degrees Celsius or higher). Further, even with the loss of gases when using boiling water, the resulting liquid is able to sufficiently extinguish and prevent fire and thus the processes described herein may use boiling water in a preferred embodiment. In an alternative embodiment where lukewarm or hot water are added, the container 138 may further include a vent to prevent cracking. Thus, the temperature of the water added at the end of the process may be selected in some embodiments based on the container 138 and the loading and storage conditions.

The fire retardant liquid produced by the above process is loaded in the container 138 and ready for use. In one or more embodiments, loading may also involve forming the liquid in situ in the container 138 and sealing the container after formation of the fire retardant liquid.

When the fire retardant liquid according to the second example encounters the heat from a fire, a chemical reaction takes place and the ammonium dihydrogenphosphate, ammonium hydrogen carbonate, urea, and ammonium sulfate generate ammonia and carbon dioxide due to the heat of fire. Ammonia and carbon dioxide extinguish the fire as described above. In more detail, ammonium dihydrogenphosphate, ammonium hydrogen carbonate, urea and ammonium sulfate are thermally decomposed into carbon dioxide gas and ammonia gas through combustion as a result of a fire contacting the solution. Carbon dioxide gas and ammonia gas reduce air to the fire, neutralize the fire and prevent ignition or re-ignition, as described above. Further, the use of ammonium hydrogen sulfate increases the extinguishing rate relative to other ammonium compounds, such as ammonium carbonate.

In further embodiments, the fire retardant liquid may include phosphates as a chemical base. Unless the context and language clearly dictates otherwise, “phosphates” is construed broadly to mean an anion, salt, functional group, or ester derived from a phosphoric acid. In still further embodiments, the fire retardant liquid includes yet other organic and inorganic salt compounds beyond those mentioned above. Further, the fire retardant liquid may omit fluorine and other compounds that are potentially harmful to humans, animals, or the environment, such as carcinogens. The fire retardant liquid produced by the above methods is stored in the container 138 and ready for application by an end user with the nozzle 100. As noted above, a user can keep one or more containers on site for rapid and simple application with the nozzle 100 in the event of an emergency. Alternatively, the fire retardant liquid may be produced according to the above processes onsite in commercial applications.

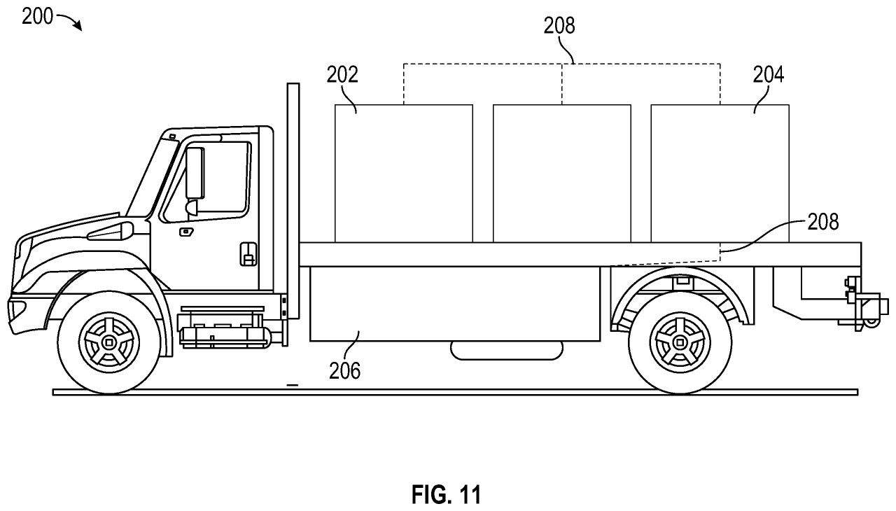

For example, FIG. 11 is a schematic illustration of an embodiment of a vehicle 200 for mixing and applying a fire retardant mixture. The vehicle 200 may be a truck or some other mobile vehicle that includes a plurality of chemical storage tanks 202 coupled to the vehicle 202 as well as a mixing tank 204 coupled to the vehicle 202. Any of the above chemical reagents may be stored in the chemical storage tanks 202 for processing onsite at a location. The vehicle 200 further includes a heating element 206 coupled to the vehicle 200 for heating water to the prescribed temperatures according to the above processes. The heating element 206 is in fluid communication with a water source, which may be a further tank on the vehicle 200, a fire hydrant, a lake, a stream or river, or another like water source. In some embodiments, the vehicle 200 further includes a pump in fluid communication with the water source and the heating element 206 for providing water to the heating element 206. The vehicle 200 may also include a water softener or water purifier, or both, in fluid communication with the water source for controlling the hardness and mineral content of the incoming water, among other properties and characteristics of the water. As described above, the water softener improves the chemical mixing and surfactant bonding to reduce sedimentation and separation in the mixture. The water softener also enables use of the vehicle 200 with a wider range of water sources (i.e., water sources with water having different properties or characteristics) to achieve the chemical mixtures described above. The water softener may be selected from any water softener now known or developed in the future.

As indicated by dashed lines 208, the chemical storage tanks 202 and the heating element 206 are in fluid communication with the mixing tank 204. The mixing tank 204 is structured to receive heated water from the heating element 206 and at least one chemical reagent from the chemical storage tanks 202 to create a fire retardant mixture in the mixing tank 204 according to the processes described above. In some embodiments, the vehicle 200 includes an onboard controller for automatically supplying the ingredients for the mixture to the mixing tank 204 according to one or more recipes stored in a memory of the controller and executed by at least one processor of the controller. Such controller may also be in communication with sensors and/or actuators of the vehicle 200 associated with the tanks 202, 204, the heating element 206, as well as with electronically controlled and/or powered valves associated with the tanks 202, 204 to assist with executing the recipe. For example, the memory may store instructions that are executed by the at least one processor of the controller to send instructions, data, and/or signals to a valve associated with chemical storage tanks 202 to provide a selected amount of chemicals to the mixing tank 204, as measured via flow sensors in communication with an outlet of the chemical storage tanks 202 and the onboard controller. The instructions may also include instructions, data, and/or signals for activating the heating element 206 to warm water provided to the heating element 206 until the temperature of the water is within an acceptable range for mixing, as determined by a sensor in communication with the water heated by the heating element 206. Alternatively, the ingredients may be added to the mixing tank 204 manually. Still further, the mixing tank 204 may include a mixing assembly, such as a mixing blade, auger, screw, paddle, or some other like structure for mixing the solution in the mixing tank 204. The mixing assembly may be actuated by a drive assembly on the vehicle 200 and in communication with the controller or may be manually operated.

Because a comparatively small amount of chemical reagent can be used to produce a large volume of fire retardant liquid (i.e., 50 to 70 grams or less of each reagent per 500 ml of fire retardant liquid), the vehicle 200 can provide a large supply of fire retardant liquid before requiring a refill of the reagents. Thus, the vehicle 200 can be driven to a remote area and connected to a water source. The mixing tank 204 then receives heated water from the heating element 206 and the chemical reagents are added to the water in the mixing tank 204 from the chemical storage tanks 202 to create a fire retardant liquid or mixture in the mixing tank 204. The resulting fire retardant mixture can then be applied to a selected area via an outlet of the mixing tank 204. In some embodiments, the outlet of the mixing tank 204 is connected to a hose to extend the range of application which may also be powered by a pump to increase the volume of mixture output by the vehicle 200 as well as the distance the material can be thrown by the vehicle.

In some embodiments, the vehicle 200 mixes and outputs the fire retardant liquid without further dilution with water, or alternatively, the outlet of the mixing tank 204 may be in fluid communication with the water source to dilute the fire retardant liquid to the concentrations discussed herein to further increase the volume of liquid produced with the reagents in the chemical storage tanks 202. Still further, the vehicle 200 may mix and output the fire retardant liquid in real time, or there may be slight delay between batches of fire retardant liquid. Even with a delay, the time lost will be considerably less than known methods of applying fire retardants, such as with a helicopter or plane, because the vehicle 200 does not need to be moved between applications and the time required to prepare a new batch of liquid is less than the time required for the plane or helicopter to complete a round trip to a remote area in many cases.

In some embodiments, the vehicle 200 may include a trailer towing any of the above features of the vehicle 200, such as additional reagent tanks 202, additional mixing tanks 204, the heating element 206, or the water softener, among others, to increase the volume of fire retardant mixture that may be applied to a given area before refilling or reduce the delay between batches of fire retardant mixture. Still further, the vehicle 200 may be part of a system or fleet of vehicles. In an embodiment, all of the vehicles are identical to vehicle 200 and all of the vehicles 200 can be deployed at once to provide a large volume of fire retardant mixture to a selected area. In some embodiments, the vehicles in the fleet have different purposes, such as a selected number of vehicles for mixing and applying the fire retardant mixture and a selected number of vehicles for replenishing the materials to create the fire retardant mixture to allow for continuous application of fire retardant mixture. In one non-limiting example, a first vehicle in the fleet may be similar to vehicle 200 that is deployed on site at a selected location to mix and provide the fire retardant mixture. In the meantime, a second vehicle with only a single large chemical storage tank 202 travels to and from a reagent source or storage location to bring more reagent and other components of the mixture to the first vehicle 200 and replenish the first vehicle 200. As such, the fleet of vehicles may enable the continuous application of fire retardant mixture to a selected location, which is a significant advantage over known fire retardant systems, devices, and methods.

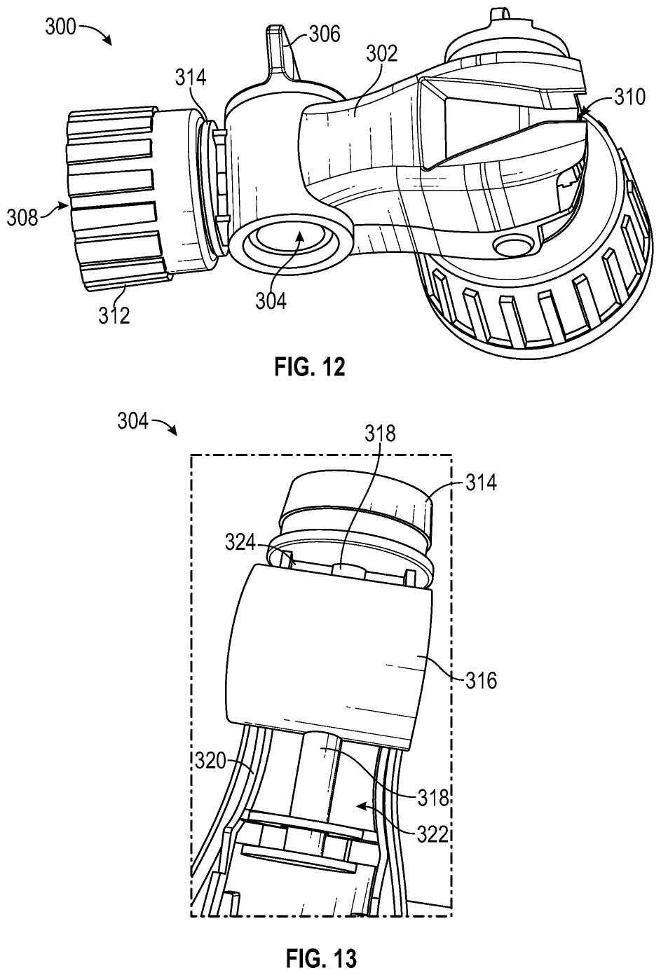

FIGS. 12-15 are various views of an embodiment of a nozzle 300 according to the present disclosure. The nozzle 300 may be similar to the nozzle 100, except as otherwise described herein. Beginning with FIG. 12, the nozzle 300 is shown in a top isometric view and includes a body 302 with a flow control device 304 received internal to the body 302. The flow control device 304 interfaces with a valve 306 and is structured to convey fluid from an inlet 308 of the flow control device 304 through at least a portion of the body 302 toward an outlet 310 of the nozzle 300. The inlet 308 of the flow control device 304 may be structured to interface with a garden hose and the valve 306 may be a quarter turn valve operable to control introduction of fluid from the inlet 308 to the flow control device 304 and the nozzle. In more detail, the nozzle 300 may include a collar 312 that is coupled to a connector 314 of the flow control device 304 that defines the inlet 308. The collar 312 may include threads for engaging corresponding threads on a connector of a garden hose.

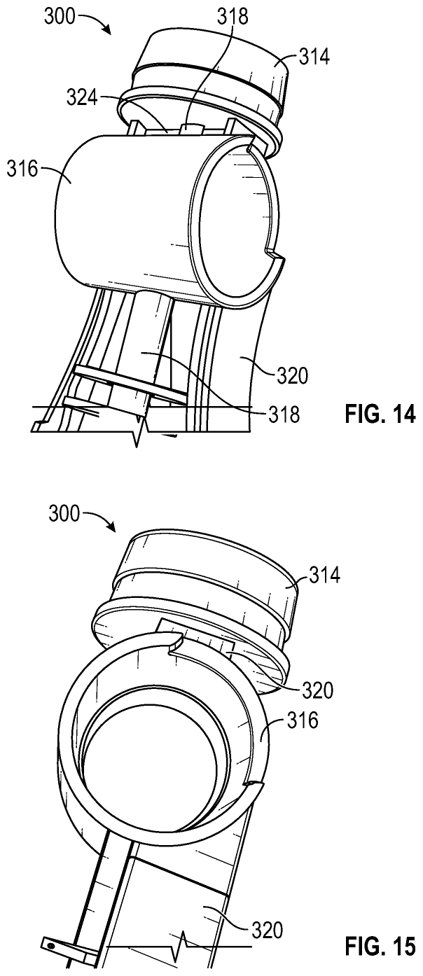

FIGS. 13-15 are various views providing additional detail of the flow control device 304 of the nozzle 300. In particular, FIG. 13 is a top plan view of the flow control device 304, FIG. 14 is an isometric view showing the top and right sides of the flow control device 304, and FIG. 15 is a right side elevational view of the flow control device 304. With reference to FIGS. 13-15, the flow control device 304 includes a barrel 316 coupled to the connector 314 and flow lines or pipes 318 in communication with the barrel 316 and the connector 314. In an embodiment, the flow control device 304 may include a first flow line 318 in communication with the barrel 316 and a second flow line 318 in communication with the barrel 316 and the connector 314. As best shown in FIG. 15, the barrel 316 may be a hollow cylinder that is closed at opposite open ends by the valve 306 or another like device in the nozzle 300 of FIG. 12. The valve 306 may selectively control flow of fluid through the barrel 316 and the flow lines 318.

The barrel 316 and the connector 314 are coupled to, and supported by, a frame 320. The frame 320 may include frame elements that extend between an outer periphery of each of the barrel 316 and the connector 314. As shown in FIG. 13, there is an air gap or space 322 between the flow line 318 and the barrel 316 at a bottom of the flow control device 304 in the orientation of FIG. 13. Further, the frame 320 includes frame elements implemented as flanges or generally flat and planar molded support members that extend between the barrel 316 and the connector 314. In the nozzle 100, there may be a similar air gap or space 322 between the barrel 316 and the connector 314, as shown, for example, in FIG. 6.

To provide additional support and rigidity for the connection between the connector 314 and the barrel 316, the space between the connector 314 and the barrel 316 of the flow control device 304 may be at least partially, or completely, filled with material 324. The material 324 may be provided in a form factor of a generally flat and planar plate that fills the space between the connector 314 and the barrel 316, and at least partially surrounds the flow line 318 between the connector 314 and the barrel 316. More specifically, the material 324 is in contact with, coupled to, and extends between the connector 314, the barrel 316, the flow line 318, and the frame 320 between the connector 314 and the barrel 316. In an embodiment, a thickness of the material 324 is selected and may be greater than, less than, or equal to, a thickness of the frame 320 between the connector 314 and the barrel 316. The material 324 provides additional support and reduces the likelihood of damage to the flow control device 304 and the connections of various components during normal operation. In an embodiment, the material 324 is implemented as a web between the frame elements 320 on either side of the barrel 316 and flow line 318 such that the combination of the frame elements 320 and the material 324 has a configuration similar to an I-beam. As a result, the material 324 may improve the useful life of the flow control device 304 and the nozzle 300 in some embodiments.

In further embodiments, the nozzles 100, 300 may have a different design while still performing at least some techniques described herein. For example, the present disclosure contemplates different nozzle arrangements and configurations for mixing and applying fire retardant liquids. Such nozzles may include only a single, or more than two inlets. Further, such nozzles may include only one, or more than one, outlet, along with one, two, three, or more flow paths through the nozzle. Such nozzles may also be configured to interface with a wide range of liquid sources for the mixing and application of fire retardant, including but not limited to garden hoses, fire hydrants, fluid tanks, fluid pumps, and external liquid storage containers. In addition, nozzles are contemplated herein for directly applying fire retardant liquid from a container or other source without an external water source. Additional variations are possible. Accordingly, the present disclosure and the following claims are not limited to the embodiments of nozzles shown and described herein.

As such, the present disclosure provides devices, systems, and methods for mixing and applying a fire retardant that are easy for users to apply in the event of an emergency. The concepts of the disclosure can be utilized by homeowners and other end users as well as in commercial applications. Further, the concepts of the disclosure slow the spread of fire or prevent fire from spreading to the property while also not staining structures and providing for easier cleaning relative to known fire retardants after the threat of fire has passed. The fire retardants described herein also do not require re-application of water to maintain their effectiveness, but rather, can be applied before evacuating an area with the fire retardants maintaining their effectiveness for days, weeks, months, or longer (i.e., until the fire retardant is washed off). The use of a vehicle to mix and apply fire retardant onsite at a location allows for efficient application of fire retardant in a large area with significantly reduced costs and is more efficient for use in remote areas.

Certain words and phrases used in the specification are set forth as follows. As used throughout this document, including the claims, the singular form “a”, “an”, and “the” include plural references unless indicated otherwise. Any of the features and elements described herein may be singular, e.g., a nozzle may refer to one nozzle. The terms “include” and “comprise,” as well as derivatives thereof, mean inclusion without limitation.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated.

Generally, unless otherwise indicated, the materials for making the invention and/or its components may be selected from appropriate materials such as plastics, metal, metallic alloys (high strength alloys, high hardness alloys), composite materials, ceramics, intermetallic compounds, wood, inorganic and organic salts, phosphates, and the like.

The foregoing description, for purposes of explanation, uses specific nomenclature and formula to provide a thorough understanding of the disclosed embodiments. It should be apparent to those of skill in the art that the specific details are not required in order to practice the invention. The embodiments have been chosen and described to best explain the principles of the disclosed embodiments and its practical application, thereby enabling others of skill in the art to utilize the disclosed embodiments, and various embodiments with various modifications suited to the particular use are contemplated. Thus, the foregoing disclosure is not intended to be exhaustive or to limit the invention to the precise forms disclosed, and those of skill in the art recognize that many modifications and variations are possible in view of the above teachings.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, including U.S. Provisional Application No. 63/249,475 filed Sep. 28, 2021 and U.S. Provisional Application No. 63/395,690 filed Aug. 5, 2022, are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the breadth and scope of a disclosed embodiment should not be limited by any of the above-described embodiments, but should be defined only in accordance with the following claims and their equivalents.

1. A system for applying a fire retardant with a hose, comprising:
a nozzle including:
a first fluid inlet;
a second fluid inlet in fluid communication with the first fluid inlet, the second fluid inlet being coupleable to the hose; and
a fluid outlet in fluid communication with the first fluid inlet and the second fluid inlet to define a fluid path through the nozzle;
a straw coupled to the first fluid inlet of the nozzle;
a container removably coupled to the first fluid inlet of the nozzle with the straw received in the container; and
a fire retardant liquid in the container,
the nozzle structured to receive water from the hose via the second fluid inlet of the nozzle and mix the water with the fire retardant liquid in the container via the straw and the first fluid inlet to create a fire retardant mixture and discharge the fire retardant mixture through the fluid outlet of the nozzle under pressure from water in the hose.

2. The system of claim 1, wherein the nozzle further includes:
a first valve in fluid communication with the fluid path between the first fluid inlet and the fluid outlet, the first valve being manipulatable between a closed position and an open position.

3. The system of claim 2, wherein the nozzle further includes:
a second valve in fluid communication with the fluid path between the second fluid inlet and the fluid outlet, the second valve being manipulatable between a closed position and an open position.

4. The system of claim 3, wherein the first valve controls only introduction of the fire retardant chemical into the fluid path and the second valve controls only introduction of water into the fluid path.

5. The system of claim 1, wherein the nozzle includes a first collar corresponding to the first fluid inlet and having a first diameter and a second collar corresponding to the second fluid inlet and having a second diameter smaller than the first diameter.

6. The system of claim 5, wherein the container has a neck with a plurality of threads structured to engage the first collar.

7. The system of claim 1, wherein the straw has a length from a first end to a second end opposite the first end, the straw including a longitudinal axial bore through the straw from the first end to the second end, the longitudinal axial bore defined by an inner surface of the straw including a plurality of lands and grooves in an alternating helical configuration to increase flow rate of the fire retardant liquid through the straw.

8. The system of claim 1, wherein the nozzle is structured to discharge the fire retardant mixture at least 15 feet from the nozzle when coupled to a standard municipal water supply.

9. The system of claim 1, wherein the container has a volume between 8 fluid ounces and 192 fluid ounces.

10. The system of claim 1, wherein the container includes a handle.

11. The system of claim 1, wherein the container is a first container with a first thread ratio being coupleable with the first fluid inlet of the nozzle, the system further comprising:
a second container with a second thread ratio different than the first thread ratio.

12. The system of claim 11, further comprising:
an adapter including a first connector with the first thread ratio and a second connector with the second thread ratio, the adapter being coupleable to the first fluid inlet of the nozzle and the second container.

13. The system of claim 1, wherein the fire retardant mixture has a ratio of water to fire retardant liquid between 1:5 and 1:15.

14. The system of claim 1, further comprising:
an air hole in the nozzle or in the container structured to allow air to enter the container and replace fire retardant liquid leaving the container through the straw.

15. A vehicle for mixing and applying a fire retardant, comprising:
at least one chemical storage tank coupled to the vehicle or towed by the vehicle or associated with a second vehicle;
at least one reagent in the at least one chemical storage tank;
a heating element coupled to the vehicle or towed by the vehicle or associated with the second vehicle;
a water softener;
a water inlet in fluid communication with the heating element and the water softener, the water inlet being coupleable to a water source;
a mixing tank; and
a fluid outlet in fluid communication with the mixing tank,
the mixing tank structured to receive heated water from the heating element and the at least one chemical reagent from the at least one chemical storage tank to create a fire retardant mixture in the mixing tank,
the fluid outlet structured to discharge the fire retardant mixture from the mixing tank.

16. The vehicle of claim 15, wherein the at least one reagent is one or more of sodium chloride, ammonium dihydrogenphosphate, and ammonium hydrogen carbonate.

17. The vehicle of claim 15, wherein the heated water has a temperature ranging from 30 degrees Celsius to 70 degrees Celsius.

18. The vehicle of claim 15, wherein the fire retardant mixture includes a surfactant.

19. A method for dispersing a fire retardant solution, comprising:
providing a container of fire retardant;
coupling a nozzle to the container, the nozzle having a straw configured to be inserted into the container to draw fire retardant from the container;
coupling the nozzle to a water hose connected to a municipal water supply;
activating the municipal water supply to allow water to pass through the nozzle and combine with the fire retardant to create a fire retardant mixture; and
discharging the fire retardant mixture from the nozzle.

20. The method of claim 19, wherein the providing the container of fire retardant includes providing the container with a fire retardant solution.

21. The method of claim 20, wherein the providing the container with the fire retardant solution includes providing the container with a surfactant in the fire retardant solution.

22. The method of claim 19, wherein the discharging the fire retardant mixture includes discharging the fire retardant mixture with a ratio of water to fire retardant between 1:1 and 3:1.

23. The method of claim 19, wherein the discharging the fire retardant mixture includes discharging the fire retardant mixture at least 15 feet from the nozzle.
